(19) United States
(12) Patent Application Publication
(10) Pub. No.: US 2016/0187636 A1
(43) Pub. Date: Jun. 30, 2016

(54) Microscopy Blade System And Method Of Control

(71) Applicant: PRESIDENT AND FELLOWS OF HARVARD COLLEGE, Cambridge, MA (US)

(72) Inventors: Donald E. Ingber, Boston, MA (US); Daniel Levner, Cambridge, MA (US); Guy Thompson, Lexington, MA (US); Christopher D. Hinojosa, Cambridge, MA (US); Jose Fernandez-Alcon, Cambridge, MA (US)

(21) Appl. No.: 14/899,550

(22) PCT Filed: Jun. 26, 2014
(86) PCT No.: PCT/US2014/044381

§ 371 Date: Dec. 17, 2015

Related U.S. Application Data
(60) Provisional application No. 61/839,637, filed on Jun. 26, 2013.

(51) Int. Cl. G02B 21/24; G02B 21/02; G02B 21/16; G02B 21/34; G02B 21/36; G02B 21/14; G02B 21/06; G02B 7/04

(52) U.S. Cl. CPC G02B 21/24; G02B 21/06; G02B 21/02; G02B 7/04; G02B 21/34; G02B 21/36; G02B 21/14; G02B 21/16

(57) ABSTRACT

A microscopy system for monitoring of one or more specimens includes a plurality of microscope blades, each microscope blade having at least one objective, at least one illuminator, and at least one detector. The microscopy system also includes a plurality of carriages, each carriage being connected to one or more of the microscope blades, and one or more actuators configured to drive the plurality of carriages along one or more axes, at least some of the plurality of carriages having at least partially overlapping ranges of motion along at least one of the one or more axes. The microscopy system also includes a master controller configured to drive each of the carriages, using the actuator(s), along the one or more axes.

### CROSS-REFERENCE TO RELATED APPLICATIONS

This application claims benefit under 35 U.S.C. §119(e) of the U.S. Provisional Application No. 61/839,637 filed Jun. 26, 2013, the content of which is incorporated herein by reference in its entirety.

### GOVERNMENT SUPPORT

This invention was made with government support under grant no. W911NF-12-2-0036 awarded by the United States Army. The government has certain rights in the invention.

### FIELD OF THE INVENTION

The invention relates to microscopy devices and systems, as well as to methods pertaining to use of such microscopy devices and systems.

### BACKGROUND OF THE INVENTION

Conventional microscopy systems focus on the imaging of a particular specimen of interest and a balancing of all constituent elements a particular microscopy system (e.g., illumination, lenses, filters, mirrors, condenser, specimen, objective, imaging system, etc.) and specimen of interest (e.g., specimen preparation, etc.), together with control of environmental conditions (e.g., vibrations, temperature, etc.) of both the microscopy system and specimen. Despite the many advances seen in the resolution and contrast achieved for imaged specimens, the underlying monolithic nature of conventional microscopy systems introduces significant physical and process limitations on throughput.

### SUMMARY OF THE INVENTION

In one aspect of the present concepts, a microscopy system for monitoring of one or more specimens includes a plurality of microscope blades, each microscope blade having at least one objective, at least one illuminator, and at least one detector. The microscopy system also includes a plurality of carriages, each carriage being connected to one or more of the microscope blades, and actuator(s) configured to drive the plurality of carriages along one or more axes, at least some of the carriages having at least partially overlapping ranges of motion along at least one of the one or more axes. The microscopy system also includes a master controller configured to drive each of the carriages, using the actuator(s), along the one or more axes.

In yet another aspect of the present concepts, a method is provided for controlling a microscopy system comprising a plurality of movable microscope blades movably disposed along a range of positions along one or more axes, at least some of the plurality of positions for the plurality of movable microscope blades along the range of positions being at least partially overlapping. The method includes the act of using a controller to determine a mechanical motion request for a movable microscope blade disposed at a first location to move to a second location, at least one of the first location or the second location being within the at least partially overlapping ranges of motion along the one or more axes. The method also includes the act of using the controller, or another controller, to cause at least one actuator to move the movable microscope blade from the first location to the second location.

In at least one aspect of the present concepts, a method of controlling a microscopy system having a plurality of movable microscope blades includes the act of using a master controller to determine a mechanical motion request for a movable microscope blade. In accord with the method, a collision avoidance controller is used to analyze the mechanical motion request to determine if a correction to the mechanical motion request is required to avoid contact between the movable microscope blade and any of the remainder of the plurality of microscope blades arising from movement of the movable microscope blade in accord with the mechanical motion request and, if so, output to the movable microscope blade or an actuator associated with the movable microscope blade a modified mechanical motion request. In accord with the method, the movable microscope blade is moved in accord with one of the mechanical motion request or the modified mechanical motion request.

The above summary is not intended to represent each embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of the exemplary embodiments and modes for carrying out the present invention when taken in connection with the accompanying drawings and appended claims.

### BRIEF DESCRIPTION OF THE FIGURES

FIGS. 1A-1C depicts example of specimens that may advantageously be imaged in combination with at least some aspects of the present concepts.

FIG. 2 shows a first side perspective representation of a Microscope Blade in accord with at least some aspects of the present concepts.

FIG. 3 shows a second side perspective representation of the Microscope Blade represented in FIG. 2, in accord with at least some aspects of the present concepts.

FIG. 4 shows a rear view representation of the Microscope Blade represented in FIGS. 2-3, in accord with at least some aspects of the present concepts.

FIG. 5 shows a rear perspective representation of the Microscope Blade represented in FIGS. 2-4, in accord with at least some aspects of the present concepts.

FIGS. 6A-6B show perspective representations of Microscope Blade system configurations in accord with at least some aspects of the present concepts wherein one or more Microscope Blades, such as those represented by way of example in FIGS. 2-5, are disposed to translate within one or more rails.

FIGS. 7A-7C show examples of collision avoidance control configurations and schemes in accord with at least some aspects of the present concepts.

FIG. 8 is a schematic representation of an embodiment of an Organ Interrogator with a Cartridge-dock being examined by several Microscope blades in accord with at least some aspects of the present concepts.

The present disclosure is susceptible to various modifications and alternative forms, and some representative embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the invention as defined by the appended claims.

### DETAILED DESCRIPTION

One significant advantage of at least some aspects of the microscopy systems and methods described herein is that such at least some aspects provide the ability to monitor, in parallel or sequentially, a plurality of microfluidic devices, or specimen substrates. As one example, an exemplary microfluidic device comprises an organ mimic device, such as is disclosed in U.S. Pat. No. 8,647,861 to Ingber et al., which is incorporated by reference in its entirety herein. Such organ mimic devices to a microfluidic device which at least one physiological function of at least one mammalian (e.g., human) tissue or organ. While the organ mimic device referred to herein are described to mimic a physiological function of a mammalian organ, it is to be understood that such organ mimic devices can be designed to mimic the functionality of any living tissue or organ from humans or other organisms (e.g., animals, insects, plants). Thus, as used herein, the term organ mimic device (hereinafter “Organ Chip”) in not limited to just those that mimic a mammalian tissue or organ, but includes Organ Chips which can mimic the functionality of any living tissue or organ from any organism including mammals, non-mammals, insects, and plants. Exemplary examples of Organ Chips and associated systems are disclosed in WO2013/086486A and WO 2013/086502 A1, which are each incorporated by reference in their entireties herein.

In some embodiments, the microscopy systems and methods described herein can be used to monitor a cell culture device. The term “cell culture device” as used herein refers to a device comprising a cell culture chamber (e.g., at least one or more channels and/or wells). The cell culture device can be in a form of a microfluidic device, or a multi-well plate (e.g., but not limited to 6-well, 12-well, 24-well, 96-well, 384-well).

In some embodiments, the microscopy systems and methods described herein can be used to monitor a specimen disposed in or on any substrate, e.g., in a microfluidic device, in a cell culture device, on a microscopic slide, or on any substrate that permits light to pass through. The specimen can include, but are not limited to, biological cells, tissues and/or fluids, or physical objects such as electronic components, particles, fibers, and quality control samples.

Generally, the Organ Chips comprise a substrate and at least one (e.g., any integer such as one, two, three, four, ten, fifteen, etc.) microfluidic channels disposed therein. The number and dimension of channels in an Organ Chip can vary depending on the design, dimension and/or function of the Organ Chip. An at least partially porous or permeable and at least partially flexible membrane is positioned along a plane within at least one of the channels, wherein the membrane is configured to separate said channel to form two sub-channels, wherein one side of the membrane can be seeded with at least one tissue- or organ-specific cell type, e.g., at least one type of tissue- or organ-specific parenchymal cells, and the other side of the membrane can be optionally seeded with at least one cell type, e.g., vascular endothelial cells.

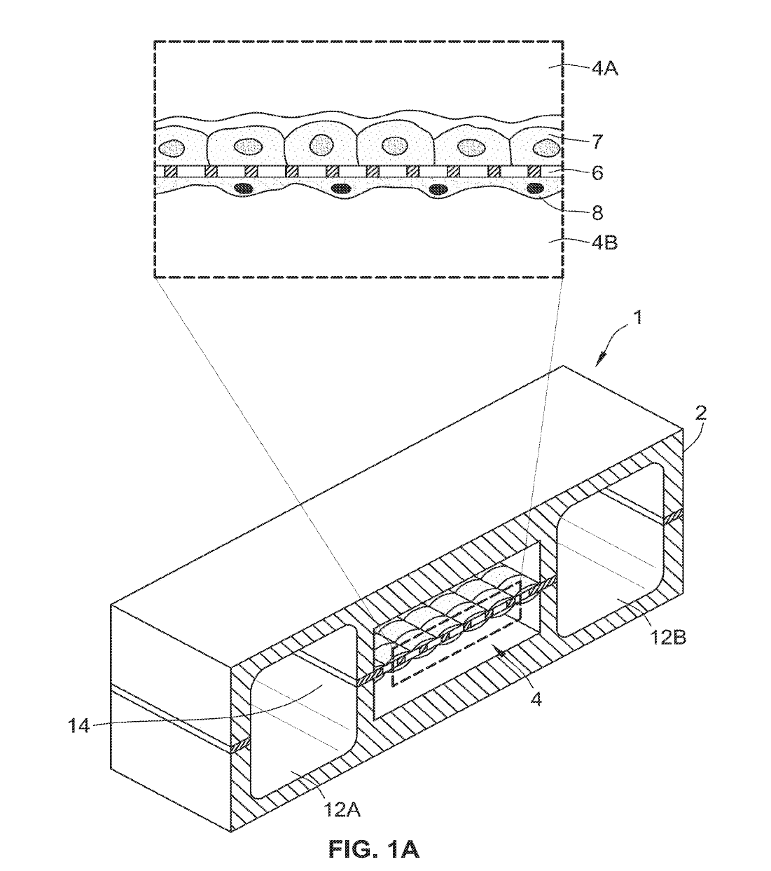

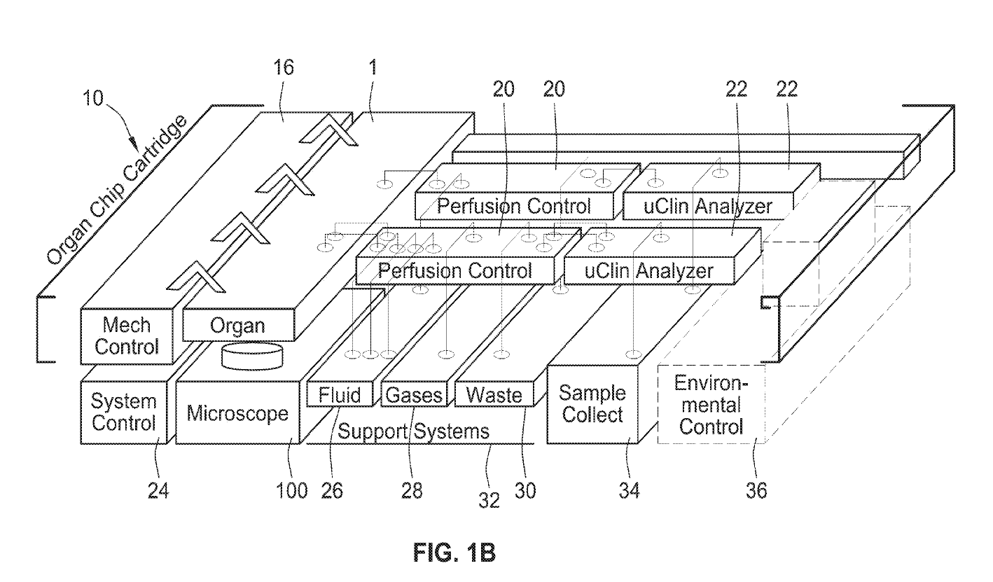

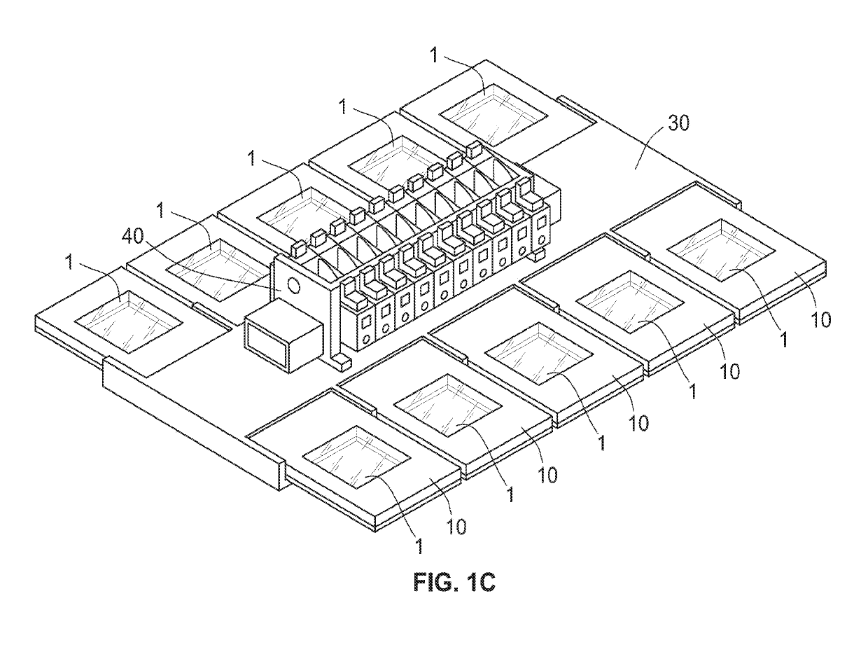

An example of one Organ Chip, a lung-on-a-Chip 1 (hereinafter “lung Chip”), is represented in FIG. 1A. The lung Chip 1 comprises a body 2 defining a central microchannel 4 therein; and an at least partially porous or permeable and at least partially flexible membrane 6 positioned within the central microchannel 304 and along a plane to divide the central microchannel 4 to form a first central microchannel 4A and a second central microchannel 4B, wherein a first fluid is applied through the first central microchannel 4A and a second fluid is applied through the second central microchannel 4B. There is at least one operating channel (12A, 12B) separated from the first 4A and second 4B central microchannels by a first microchannel wall 14. While FIG. 1A illustrates an Organ Chip with operating channel(s) to flex the membrane, the Organ Chip can be adapted to modulate the movement of the membrane by other mechanisms, e.g., mechanical and/or pneumatic mechanisms. Exemplary designs of Organ Chips to modulate membrane movement are described, e.g., in the U.S. provisional application No. 61/919,181, the content of which is incorporated herein by reference in its entirety.

The membrane 6 is mounted to the first microchannel wall 14, and when a pressure is applied to the operating channel (12A and/or 12B), it can cause the membrane to expand or contract along the plane within the first 4A and the second 4B central microchannels. As shown in the non-limiting example of FIG. 1A, one side of the membrane 6 is seeded with alveolar epithelial cells 7 to mimic an epithelial layer, while another side of the membrane is seeded with lung microvascular endothelial cells 8 to mimic capillary vessels. In this example, the lung Chip 1 can be used to mimic an alveolar-capillary unit, which plays a vital role in the maintenance of normal physiological function of the lung as well as in the pathogenesis and progression of various pulmonary diseases. In at least some aspects of such an embodiment, a gaseous fluid, e.g., air and/or aerosol, is passed through the first central microchannel 4A in which the alveolar epithelial cells 7 reside, while a liquid fluid (e.g., culture medium, buffered solution, blood, and/or blood substitute) is passed through the second central microchannel 4B (Microvascular channel) in which the microvascular endothelial cells 8 reside.

Without limitations, Organ Chips 1 can comprise additional cell types, such as immune system cells, stromal cells, neurons, lymphatic cell, adipose cell, gut microbiome cells, by way of example, based on the goal of the Organ Chip application, such as is described in the international patent application no. WO 2013/086502 A1, the contents of which are incorporated here by reference in their entirety. Likewise, depending on the Organ Chip 1 application, the dimensions of each of the one or more channels in each Organ Chip can be particularly dimensioned to a desired channel function (e.g., as a conduit for fluid transfer or as a chamber for cell culture, for subsequent monitoring of cellular response, etc.), flow conditions, tissue microenvironment to be simulated, and/or methods for detecting cellular response. Cross-sectional dimensions of the channels can vary from about 10 μm to about 1 cm or from about 100 μm to about 0.5 cm.

Exemplary Organ Chips 1 amenable to the present disclosure are described, for example, in U.S. Provisional Application No. 61/470,987, filed Apr. 1, 2011; No. 61/492,609, filed Jun. 2, 2011; No. 61/447,540, filed Feb. 28, 2011; No. 61/449,925, filed Mar. 7, 2011; and No. 61/569,029, filed on Dec. 9, 2011, in U.S. patent application Ser. No. 13/054,095, filed Jul. 16, 2008, and in International Application No. PCT/US2009/050830, filed Jul. 16, 2009 and PCT/US2010/021195, filed Jan. 15, 2010, and U.S. Provisional Application Nos. 61/483,837 and 61/541,876, the contents of all of which are incorporated herein by reference in their entirety. Muscle Organ Chips are described, for example, in U.S. Provisional Patent Application Ser. No. 61/569,028, filed on Dec. 9, 2011, U.S. Provisional Patent Application Ser. No. 61/697,121, filed on Sep. 5, 2012, and PCI patent application titled “Muscle Chips and Methods of Use Thereof,” filed on Dec. 10, 2012 and which claims priority to the US provisional application nos. 61/569,028, filed on Dec. 9, 2011, U.S. Provisional Patent Application Ser. No. 61/697,121, the entire contents of all of which are incorporated herein by reference in their entireties. Additional exemplary Organ Chips 1 amenable to the present disclosure are described, for example, in the International Patent Application Nos.: WO 2010/009307, WO 2012/166903, WO 2012/118799, WO 2013/086486, and WO 2013/086502, and in the U.S. Provisional Patent Application Nos. 61/919,193 filed Dec. 20, 2013; 61/919,181 filed Dec. 20, 2013, the contents of which are incorporated herein by reference in their entireties. Appurtenant systems for such Organ Chips 1 may comprise, for example, control ports for application of mechanical deformation, electrical connections, as shown in at least some of the aforementioned applications and publications, the contents of which are incorporated herein by reference in their entirety.

In some embodiments, Organ Chips 1 can be fabricated from any biocompatible material(s). Examples of biocompatible materials include, but are not limited to, glass, silicon, silicones, polyurethanes, rubber, molded plastic, polymethylmethacrylate (PMMA), polycarbonate, polytetrafluoroethylene (TEFLON™), polyvinylchloride (PVC), polydimethylsiloxane (PDMS), and polysulfone. In one embodiment, Organ Chips can be fabricated from PDMS (poly-dimethylsiloxane).

One of skill in the art can design and determine optimum number and dimension of channels required to achieve a certain application. For example, an Organ Chip 1 can be constructed to comprise at least two (e.g., two, three, four, five, etc.) identical channels. This configuration can provide multiple read-outs per Organ Chip, which can be useful for the culture of biological material and/or assessing reproducibility.

In some embodiments, outflow of a channel on an Organ Chip 1 can be routed into another Organ Chip or a same type or a different type. In at least some aspects, this may permit mimicking the interconnection of various Organs. For example, outflow of one Organ Chip's interstitial and/or microvascular channel can be routed into another. Accordingly, an integrated network can be developed, in accordance with various applications, by using different combinations of Organ Chips and/or Organ Cartridges having one or more Organ Chips disposed thereon.

In at least some aspects, each Organ Chip 1 forms part of a system comprising one or more fluid control element(s) (e.g., pump(s), valve(s), rotary valve(s), pneumatic valve(s), restriction(s), nozzle(s), etc.) to modulate a fluid flow within at least one channel of the Organ Chip. In some aspects, the Organ Chip 1 can comprise one or more bubble traps, oxygenators, gas-exchangers (e.g., to remove carbon dioxide), and in-line microanalytical functions, such as is disclosed by way of example in U.S. Provisional Application No. 61/696,997, filed Sep. 5, 2012, and U.S. Provisional application titled “Cartridge Manifold and Membrane Based-Microfluidic Bubble Trap,” filed on filed on Dec. 10, 2012, and International Patent Application No. WO 2014/039514, the contents of each of which are incorporated herein by reference in their entireties. Organ Chips 1 can utilize enhanced perfusion control to permit fine fluidic control and real-time metabolic sensing functions (e.g., O₂, pH, glucose, lactate), as well as feedback control capabilities, as required, to adjust the physical and chemical conditions of the Organ Chip.

As noted above, the Organ Chips 1 may comprise, without limitation, Brain Organ Chips, Gut Organ Chips, Kidney Organ Chips, Liver Organ Chips, Skin Organ Chips, Testis Organ Chips, Lung Organ Chips, Skeletal Muscle Organ Chips, Airways Smooth Muscle Chips, Bone Marrow Organ Chips, Spleen Organ Chips, and Heart Organ Chips. The viability and function of all tissues can be assessed morphologically, e.g., with optical imaging, to assess such tissues in situ to determine, for example, a status of such tissues and/or changes in a status of such tissues (e.g., changes in a status over time or changes in a status responsive to one or more adjustments to the condition(s) of the Organ Chips (e.g., modulation of a fluid flow rate (fluid shear stress), nutrient level, degree of oxygenation or acidification, addition of specific metabolites to adjust intracellular signaling levels, mechanical stimulation, cell seeding density on the membranes, cell types, ECM composition on the membrane, dimension and/or shapes of the channels, oxygen gradient, etc.)).

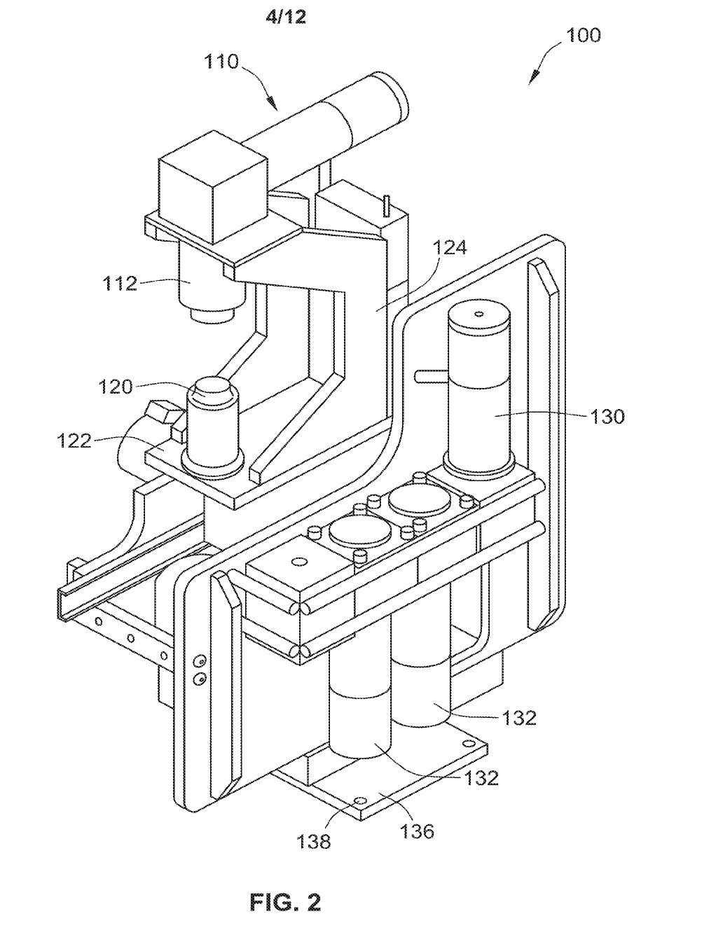

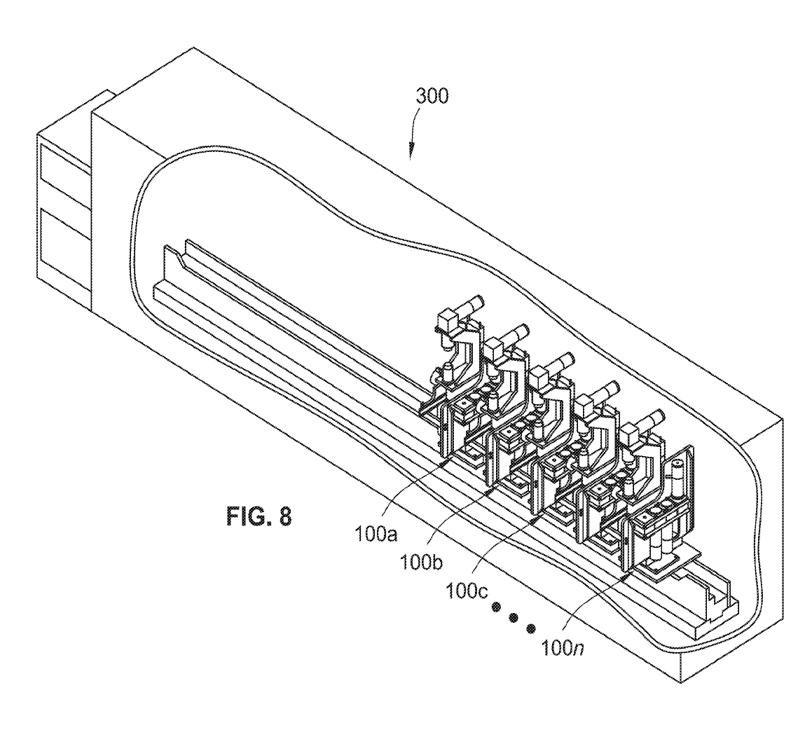

In at least some aspects, the Microscope Blade 100 shown, by way of example, in FIG. 2 is used in combination with one or more specimens, such as, but not limited to, Organ Chip(s) 1 (see. e.g., FIG. 1A). Additional examples of specimens include: microfluidic and non-microfluidic cell-culture devices; multi-well plates; microfludic assay, sensing or analysis devices; medical diagnostic samples; and biological, mechanical, electronic or material quality control samples. Where the one or more specimens comprise one or more Organ Chip(s) 1, such Organ Chip(s) may be disposed in an Organ Cartridge 10 (see. e.g., FIG. 1B), an Organ Farm or an Organ Interrogator 300 (see, e.g., FIG. 8), as described herein, or combinations thereof (e.g., an Organ Chip disposed in an Organ Cartridge that is disposed in an Organ Cartridge dock in an Organ Interrogator) and as described in WO 2013/086486 A1, published on 13 Jun. 2013, and titled “Integrated Human Organ-On-Chip Microphysical Systems,” which is incorporated by reference herein in its entirety. Another exemplary organ cartridge is also described in U.S. Provisional Patent Application No. 61/856,876, the content of which is incorporated herein by reference in its entirety.

Organ Cartridges 10, represented in FIG. 1B, can be designed for use in an Organ Farm instrument (e.g., an instrument for establishing long-term culture) or in an Organ Interrogator (e.g., for further culture and/or analysis). More specifically, an Organ Farm is an instrument or a system that supports long term culturing of cells on one or more Organ Chips, i.e., the Organ Farm provides means for culturing and maintaining living cells within an Organ Chip 1 present in the Organ Farm. The Organ Farm may comprise a controlled temperature, humidity, and gas environment capable of supporting one or more Organ Cartridges 10 or individual Organ Chip assemblies 1, each of which can be designed to create favorable fluidic, gas exchange, and nutrient conditions to foster growth and maintain the viability of multi-cell constructs which have biological properties similar to individual human or animal Organs. Generally, the Organ Farm regulates medium flow to multiple Organ Chips 1 to maintain their viability in long-term culture (e.g., greater than four weeks, etc.) and achieves this regulation of medium flow through use of (a) an apparatus or module for perfusing one or more Organ Chips with appropriate biological media using prescribed conditions, (b) a sensor or monitor adapted for monitoring at least one environmental variable, e.g., temperature, gas mixtures (e.g., CO₂ content), and the like of the one or more Organ Chips, and (c) a control system for microfluidic handling in the microfluidic circuit(s).

An Organ Interrogator system is used for assessing cell viability, function, and/or response to a test agent on each Organ Chip 1, and can contain a network of valves and ports that allow media samples to be withdrawn from the system to allow off-Chip assays of cell products (e.g., using LC/MS, nESI IM-MS, UPLC-IM-MS or other conventional analytical methodologies). An Organ Interrogator can be used to monitor and permit determination of biological effects (e.g., but not limited to, toxicity, drug efficacy, pharmacokinetics, and/or immune response) on cells in one or more Organ Chip(s) 1 arising from introduced active agents. The Organ Interrogator can include at least one valve or port that allows media sample to be withdrawn from at least one Organ Chip 1. In one example, the Organ Interrogator comprises (a) a plurality of Organ Chips; (b) an apparatus for perfusing Organ Chips in the device with an appropriate biological media, the fluid originating at the outlet of one or more Organ Chips (including recirculation), and/or one or more challenge agents using prescribed conditions; (c) an apparatus for controlling the temperature of (and optionally gas mixture provided to) said Organ Chips; and (d) a plurality of interfaces for attaching and detaching said Organ Chips to the device.

Various subsystems of the Organ Farm or Interrogator can be enclosed in a housing unit (enclosure) which can provide structure and interfaces for the integrated subsystems, which may include Organ Chips 1, Organ Cartridges 10, Cartridge Docks 30, microscope blade(s) 100, and the electronic (e.g., printed circuit boards, Master Controller, and Interface Computer), fluidic, and vacuum interface hardware. Electronics may be optionally be disposed externally to the housing unit.

Generally, an Organ Cartridge 10 comprises a base substrate that provides (i) a holder and microfluidic connections for at least one Organ Chip 1 or a port adapted for the Organ Chip disposed thereon and (ii) at least one fluidic circuit having an inlet and an outlet, in connection with the at least one Organ Chip or the corresponding port. In some embodiments, the fluidic circuit can further allow fluid communication between the Organ Chips disposed on the Organ Cartridge and/or between the Organ Cartridges. In some embodiments, the Organ Chip is embedded into the Cartridge. In at least some aspects, an Organ Cartridge 10 comprises an Organ Chip 1 in connection with a module for mechanical control 16, two Perfusion Control modules 20 and two microclinical analyzer (uClinAnalyzer) modules 22, one for each flow channel (e.g., 4A, 4B in FIG. 1A) of the Organ Chip. Each Perfusion Control module 20 is connected to one channel (e.g., 4A, 4B in FIG. 1A) of the Organ Chip 1 and one uClinAnalyzer module 22.

A system control module 24 in connection with the Organ Cartridge 10 controls the various functions and parameters on the Organ Cartridge. A microscope blade 100, in accord with the present concepts, can be disposed to image the Organ Chip 1 borne by the Organ Cartridge 10 in support of efforts to monitor and analyze a status of cells in the Organ Chip at a particular time and/or location. A sample collecting module 34 in connection with one flow channel of the Organ Chip 1 and one uClinAnalyzer module 22 and support systems 32 comprising modules for flowing fluids and gases or recovering waste from the Organ Chip may also be provided. Optionally, the Organ Cartridge can comprise an environmental control module 36 to control the environment (e.g., temperature) of the Organ Chip. In some aspects, the Organ Cartridge 10 fluidic circuit comprises at least two individual flow channels that connect with corresponding fluid channels in an Organ Chip 1. The Organ Cartridge can provide on-Chip or in-Cartridge perfusion control 20 (e.g., FIG. 1C) and microanalytic functions. For example, an Organ Cartridge 10 can comprise a single integrated unit that holds at least one Organ Chip 1 and contains Perfusion Controllers 20 and micro-clinical Analyzers 22 (μCA) comprising, in one example, micropumps, microrotary valves and μCA electrodes.

In some embodiments, one Organ Chip disposed on each Organ Cartridge can function as a whole Organ, and thus a plurality of the Organ Cartridges, each representing a different Organ, can be connected together to function as an integrated Microphysiological System or network. In some embodiments, two or more Organ Chips that each function as a different Organ can be disposed on the same Organ Cartridge, and thus the Organ Cartridge by itself can function as an integrated microphysiological network. In some embodiments, two or more Organ Chips can be interconnected to form different aspects of the same Organ. For example, different Organ Chips can be interconnected to form lung alveoli and lung small airways. In some embodiments, the Organ Chips disposed on the Organ Cartridge can perform the same and/or a different Organ-level function. In some embodiments, an Organ Chip can be integrated into the Organ Cartridge as a single integral unit. In other embodiments, the Organ Chips can be separated from the Organ Cartridges and loaded onto the Organ Cartridges prior to use.

As used herein in the context of Organ Chips, the term “interconnection,” “interconnect,” or “interconnect” refers to fluid interconnection. The fluid interconnection between two Organ Chips can be performed by direct connection, e.g., via a tubing or a microfluidic channel; or indirect connection, e.g., via a fluid transfer system that transfers an aliquot of a fluid from one Organ Chip to another Organ Chip. An exemplary fluid transfer system is described in the U.S. Provisional Application No. 61/845,666, the content of which is incorporated herein by reference in its entirety.

As shown in FIG. 1C, one or more Organ Cartridge(s) 10 can reside in a Cartridge Dock 30. The Cartridge Dock 30 can be thermally regulated by an Organ Farm instrument (e.g., for long-term culture) or an Organ-Interrogator instrument (e.g., for long-term culture and/or analysis). The Organ Cartridge 10 can also be thermally regulated by an on-board thermal control. Thus, while an Organ Cartridge 10 can be connected directly to or within an Organ Farm and/or Organ-Interrogator, the Cartridge Dock 30 (FIG. 1C) can also be used to connect the Organ Cartridge with an Organ Farm and/or Organ-Interrogator. Generally, but not necessarily, the Cartridge Dock 30 is a component of an Organ Farm or Organ Interrogator. The Cartridge Dock 30 can provide, via pump 40, fluid, gas and/or electrical connections between the Organ Cartridge 10 and Organ Farm and/or Organ-Interrogator (e.g., the Cartridge Dock 30 connects microfluidically, mechanically and/or electrically to common ports on the Organ Cartridge 10). In addition, the Cartridge Dock 30 can also provide fluid, gas and/or electrical connections between the Organ Cartridge 10 and the control and on-board and/or external analytical instrumentation. Thus, the Cartridge Dock 30 can provide fluid, gas and/or electrical connections between the Organ Cartridges 30 holding the Organ Chips 1 and the control and analytical instrumentation.

Alternatively, the Organ Dock 30 can be just a stand for holding the various components, e.g., Organ Cartridges 10, reservoirs, etc. In such embodiments, the Organ Farm or the Organ Interrogator can provide fluid, gas and electrical connections between the Cartridges holding the Organ Chips and the control and analytical instrumentation.

Without limitation, a Cartridge Dock 30 can be designed to hold any number of Organ Cartridges 10 (i.e., one or more Organ Cartridges). As shown in the example of FIG. 1C, the Cartridge Dock 30 holds ten Organ Cartridges 10. One or more pumps 40 are provided to, for example, connect Cartridge Dock 30 fluid channels to corresponding fluid channels in the Organ Cartridge(s) 30 and/or the Organ Chip(s) 1, as well as to external systems (e.g., an Organ Interrogator, as shown in FIG. 8) and modulate flow in such fluid channels.

As a subassembly in the Organ Cartridge 10, the Perfusion Controller 20 can integrate into the Organ Cartridge a plurality of fluid control elements, such as the microfluidics, valves, membrane oxygenator, gas exchangers to remove excess carbon dioxide, de-bubbler and pumps required to support a single or a plurality of Organ Chips 1 and deliver fluidic samples for either in-Cartridge analysis with the μCA 22 or external analysis by LC/MS or other laboratory techniques. As the Perfusion Controller 20 and μCA 22 can both contain customized support microfluidics, pumps, electronics, valving, and instrumentation, they can be configured as appropriate to each individual Organ type and can be configured into a single “plug-and-play” unit. The term “plug-and-play,” as used herein, generally refers to the ability of the Organ Chips 1 and/or Organ Cartridges 10 bearing Organ Chips to be plugged into a device or a system (e.g., a Cartridge Dock 30 within an Organ Farm or an Organ-Interrogator, or directly to an Organ Farm or Interrogator), and be readily available for use. In some aspects, the term “plug-and-play” further encompasses the ability of a controller (e.g., a Cartridge Dock controller within an Organ Farm or Organ-Interrogator, a computer-controlled Microscope Blade 100) to detect the connection of a new Organ Cartridge 10 or Organ Chip 1 and automatically install the necessary drivers for the operating system to interact with that Organ Cartridge or the Organ Chip disposed thereon.

Depending on various target applications (e.g., for use as a disease model or for pharmacokinetics study of a drug, etc.), different combinations of Organ Chips 1 may be selected to populate positions (e.g., Cartridge bays) within a Cartridge Dock 30.

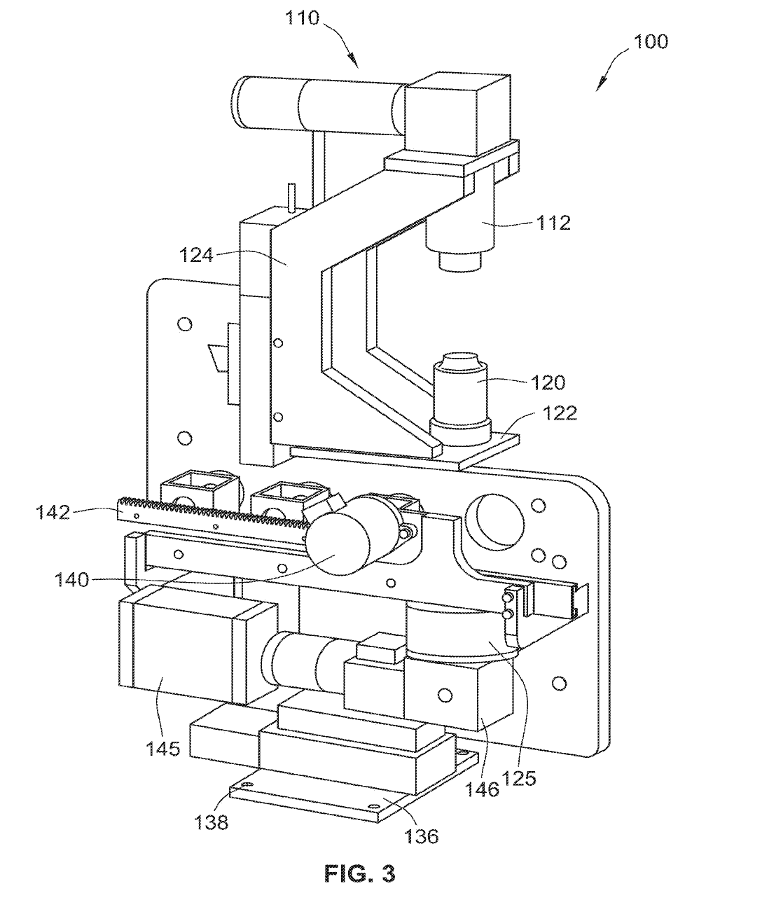

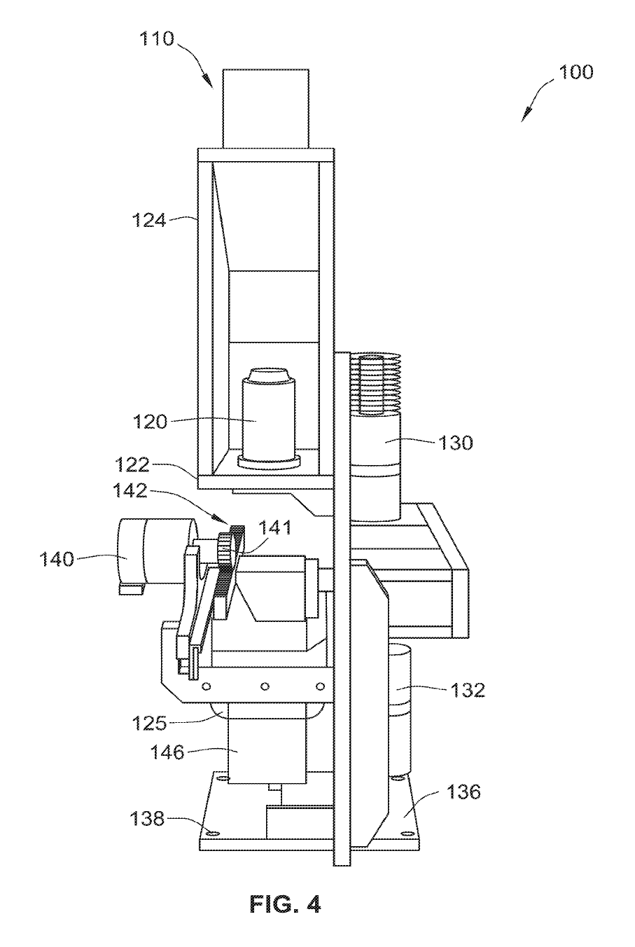

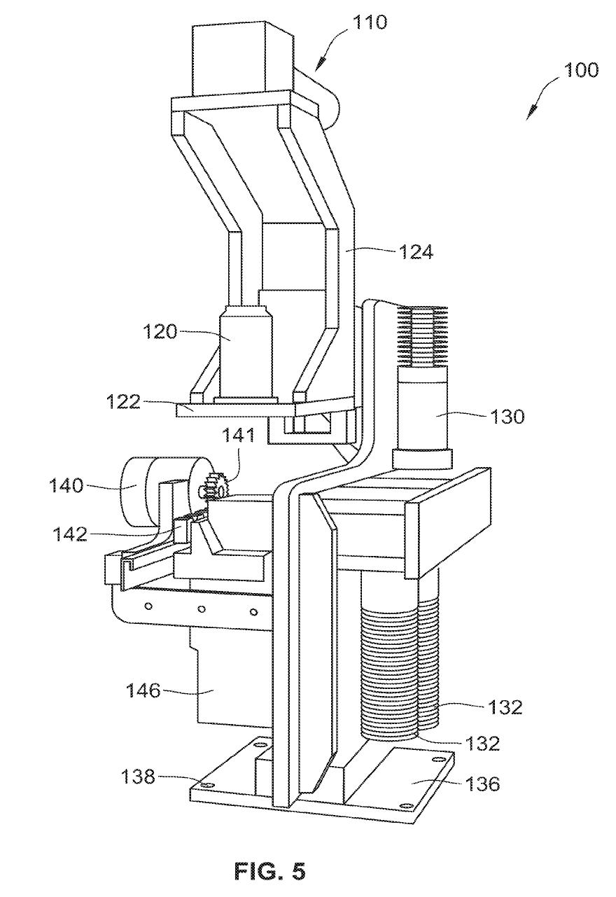

FIGS. 2-6B show microscope blades 100 in accord with at least some aspects of the present concepts. As noted above, in at least some aspects, one or more microscope blades 100 are advantageously used to provide imaging capabilities, for example, for Organ Chips 1 (e.g., disposed in an Organ Cartridge 10, disposed in an Organ Farm, disposed in an Organ Interrogator, etc.). Without limitation, each such microscope blade 100 may support one or more (e.g., a plurality of) microscopy modalities, including, for example, any one or more of brightfield, darkfield, phase-contrast, epifluorescence, fluorescence, microfluorimetry, confocal, and/or multi-proton excitation microscopy modalities. In one illustrative embodiment, such as is represented in FIGS. 2-6B, a microscope blade 100 is configured to provide both 3-color fluorescence microscopy (via, e.g., LED-based fluorescence illumination system 130, beam combiners 132, and fluorescence microscopy filter cubes 125) and phase-contrast microscopy (via, e.g., brightfield illuminator 110 and phase condenser 112), with conventional autofocus servos.

In one aspect, a microscope blade 100 is provided with Nikon CFI60 phase contrast objectives including CFI Plan Fluor DL 4× Objective na 0.13 wd 16.6 mm (PH L) (part MRH20041), a CFI Achro Flat Field DI 10× Objective na 0.25 wd 7 mm (PH 1) (MRP20102), and a CFI Plan Fluor DLL 20× Objective na 0.5 wd 2.1 mm (PH 1) (MRH10201).

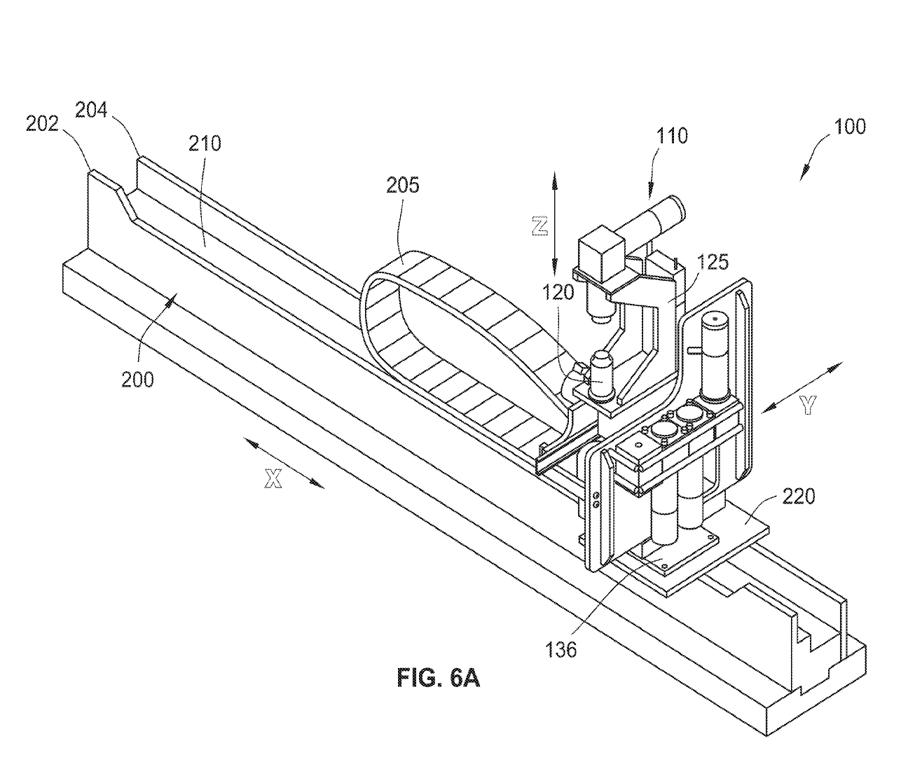

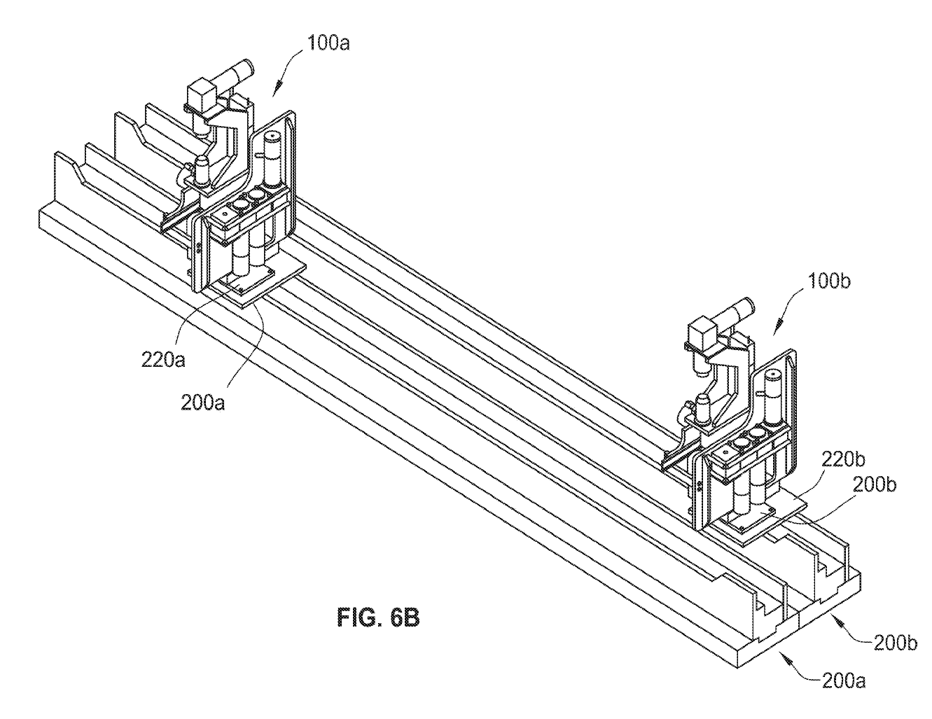

A focus control system in accord with aspects of the present concepts may utilize, by way of example, one or more actuation devices (e.g., electromagnetic motor(s), piezoelectric motor(s), sonic motor(s), voicecoil(s), stepper motor(s), rotary actuator(s), or any combination thereof, etc.) to drive one or more components of the microscope (e.g., elements comprising the optical train such as, but not limited to, an objective 120, a filter, a specimen, a condenser 112, an eyepiece, a camera, a mirror, a collector, an illumination source, etc., or subcomponents thereof) relative to one or more other components of the microscope optical train. Such movement of components relative to one another may be linearly (e.g., adjustment of an objective 120 relative to a specimen via movement of stage 122, etc.) and/or rotationally (e.g., rotation of turrets bearing various objectives and condenser annulus plates, etc.). Such internal axes of motion of microscope blade 100 components are advantageously, but optionally, combined with yet additional axes of motion external to the microscope blade (e.g., an Organ Cartridge or Organ Chip may be configured to move along one or more axes relative to the microscope blade, etc., and/or the microscope blade may be configured to move along one or more axes, as is shown by way of example in FIG. 6A).

Other automatic adjustment devices (e.g., motor 140, pinion 141, and rack 142) are advantageously provided to move various components of the microscope blade 100 relative to one another (e.g., along one or more orthogonal and/or rotational axes) to place a desired optical train of the microscope blade in an appropriate position to image a target location of a specimen of interest.

To further enhance variability of one or more microscope blades 100, a fluorescence illumination system for a microscope blade 100 may advantageously comprise one or more fluorescence filters (not shown) mounted in a motor-operated 146 filter cube 125 adapted to compactly move selected fluorescence filters with respect to (i.e., into and out of) the optical train. Although a filter turret could also be advantageously utilized in combination with the microscope blade 100, the form factor of the filter cube 125 is currently preferred in applications where the lateral footprint of the device is desired to be minimized.

In at least some aspects, in a modular microscopy system comprising a plurality of microscope blades 100a-100n, a first subset of one or more microscope blades comprises a first configuration of microscopy modality or modalities (e.g., brightfield with phase contrast) and a second subset of one or more microscope blades comprises a second configuration of microscopy modality or modalities (e.g., fluorescence). Additional subsets of microscope blades may further comprise one or more additional configurations of microscopy modality or modalities (e.g., confocal-microscopy).

The microscopy blades 100 feature a stackable form factor, so that the Organ Farm or Organ Interrogator (see, e.g., FIG. 8) can be populated with microscopy blades incrementally, as needed, providing a modular platform.

The microscope blades 100 may be motorized individually, or in groups, to permit movement along one or more axes (e.g., linearly, rotationally, etc.).

In at least some aspects of the present concepts, a microscopy system comprises a plurality of microscopy blades 100 integrated with a common motorized platform, so that the complete microscopy system can use the plurality of microscopy blades 100 to simultaneously scan a corresponding plurality of specimens (e.g., Organ Chips 1) in one, two or three dimensions, as a unit. In such configurations, imaging of a plurality of positions along a length of a plurality of specimens (e.g., an Organ Chip 1, an Organ Chip 1 disposed in an Organ Cartridge 10, etc.) is possible without the complexity involved in individually motorizing each microscope blade 100.

In some embodiments, fluorescence excitation and brightfield/phase illumination can be provided by any conventional LED or other electro-optical modules and/or light guides. LED module(s) permit(s), for example, elimination of electromechanical shutters and corresponding elimination of shutter-induced problems, such as vibration and illumination edge effects, and improved thermal stability and lower thermal loads than, for example, an incandescent or arc lamp.

While mechanical or electromechanical focusing devices can be provided to enable manual and/or automatic focusing of the specimen by adjustment of a movable stage on which or in which a specimen is disposed and/or adjustment of a component in an optical train of the microscope blade 100 (e.g., moving an objective, etc.), autofocus capability can also be implemented using software or hardware-based focus controllers. The microscope blades 100 can comprise their own microprocessor(s), microcontroller(s) or computer(s) to control operation of the constituent elements of the microscope blade 100 and to communicate with external systems (e.g., image output, data transmission, etc.). Microscope blades 100 can be configured to operate in parallel (e.g., simultaneously performing a specified action) even when sharing microprocessor(s)/computer(s) by using separate computational processes or threads for each microscope blade 100 or group of microscope blades. Alternatively, software control is provided to enable parallel operation to be attained by use of event-driven programming within a single process or thread.

Although a single microscope blade 100 may be sufficient for a given instrument (e.g., an Organ Farm), the microscope blades are configurable (e.g., minimized lateral dimensions, etc.) such that a plurality of microscope blades can be removably installed in a given instrument, such as through “Blade Slots” (not shown) or docking ports formed in the instrument to permit such removable insertion/removal of one or more microscope blades.

Merely by way of example, FIGS. 2-5 show that the exemplary microscope blade 100 depicted therein comprises a base 136 having mechanical fastener attachment points 138 provided therewith. In the illustrated example, the mechanical fastener attachment points 138 comprise through holes permitting the microscope blade 100 to be bolted onto a corresponding instrument platform. In the example of FIG. 6A, the microscope blade 100 is bolted to a movable carriage 220 via the base 136, mechanical fastener attachment points 138, and suitable bolts (not shown). Other connection schemes between the microscope blade(s) 100 and instrument may comprise, but is not limited to, corresponding male/female connection elements (e.g., mating keyed connection elements, etc.) and/or clamping elements, with or without corresponding locking members. Thus, the microscope blade 100 shown in FIG. 6A can be readily removed from the carriage 220 and replaced by a different microscope blade 100. Of course, although not presently preferred, the microscope blade 100 could be permanently affixed (e.g., by welding) to the carriage and the carriage/microscope blade assembly itself could be optionally removable from the rail. Some or all of the electrical connections to the microscope may be conveyed through the base, or conveyed separately, for example, through a wiring harness or cable management system 205.

In FIG. 6A, a single microscope blade 100 is shown to be attached to carriage 220, which is constrained to travel linearly within a U-channel linear rail 200 aligned along the X-axis. The U-channel rail 200, defined by walls 202, 204 and/or base element 210, comprises fixed or movable stop elements to constrain the limits of travel of the carriage. In the example illustrated in FIG. 6A, the rail 200 is an Aerotech (www.aerotech.com) linear motor rail utilizing an electromagnetic carriage 220 riding in a permanent-magnet lined rail. In one aspect, a 120 cm long rail 200 is used with a 100 cm travel distance between end stops. FIG. 6A shows a representation of one, non-limiting example of a cable management system 205, but any conventional cable management or wire harness system may be used in accord with the requirements of a particular application. In at least some aspects, the linear servo motor driven actuator comprises an Aerotech ACT115DL-1000-TTM linear actuator and more specifically an Aerotech ACT115DL-1000-TTM-0.5-NC-5V-CONN-H-PLOTS linear actuator with a HALAR high accuracy stage. A motion controller for the carriage 220 may comprise, for example, an Aerotech Ensemble MP Series multi-axis PWM digital controller, such as the Ensemble MP10.

Although the rail 200 is shown to be a linear rail, in other aspects of the present concepts, the rail could comprise a nonlinear rail (e.g., a curvilinear rail) that is open or closed (e.g., a rail arranged in a closed circle or ellipse).

In various aspects, the microscope blades 100 can contain their own motion hardware to permit independent movement. For example, a plurality of microscope blades 100a-n are borne by a plurality of carriages 220a-n disposed within a shared rail 200, with each of the plurality of carriages 220a-n being driven by a separate linear motor. Thus, carriage 220a and microscope blade 100a can be moved independently of carriage 220b and microscope blade 100b, which can be moved independently of carriage 220c and microscope blade 100c, and so on. Alternatively, a plurality of microscope blades 100a-n can be driven by common motion hardware to permit ganged movement. For example, two microscope blades 100a-b borne by carriages 220a-b disposed within a shared rail 200 are driven by a common motor so that carriage 220a and carriage 220b move an a unit, with microscope blades 100a, 100b likewise moving identically as a unit.

As another illustrative example, FIG. 6B shows a dual-rail microscopy system comprising a first microscope blade 100a borne by a first carriage 220a disposed within a first rail 200a, and second microscope blade 100b borne by a second carriage 220b disposed within a second rail 200b. In FIG. 6B, parallel channels of microscopy are run independently along the same axis, with each of the first carriage 220a and second carriage 220b being separately driven (e.g., by separate linear motors).

Although a linear motor drive system is illustrated, by way of example, in FIGS. 6A-6B, other drive systems may be advantageously used in accord with the present concepts. Without limitation, suitable drive systems for carriage 220 and microscope blades 100 may comprise belt drives, chain drives, rack and pinion drives, ball screw drives, hydraulic drives, or any other rotary and/or linear actuator(s). For example, a plurality of microscope blades 100a-n are disposed in a rail or track comprising a rack-drive component, with each of the microscope blades comprising a motor and pinion arranged to engage the rack-drive component, thereby permitting independent motion of that microscope blade along the track. Likewise, a plurality of microscope blades 100a-n can be disposed on individual motorized nuts (traveling screws) of a ball screw drive so that the microscope blades are able to independently move along the screw. Without limitation, the microscope blades can be actuated by any conventional mechanical actuators, hydraulic actuators, electro-mechanical actuators, linear motor, linear actuator, rotary actuator, belt actuator, or chain actuator.

The mechanical motion of the microscope blades 100a-n need not be linear. One or more of the axes about which the microscope blades 100a-n, or a subset thereof, can move include one or more radial axes. By way of example, and without limitation, a base 136 of a microscope blade 100 is configured to rotate through an angle (θ) of 360° relative to a first coordinate frame origin (O₁) of underlying carriage 220 to which it is attached. In another example, the aforementioned microscope blade 100 configured to rotate through an angle (θ) of 360° (or a lesser range of angles) relative to the first coordinate frame origin (O₁) may be disposed to move along a radial direction relative to a second coordinate frame origin (O₂) and to rotate relative thereto, or to move angularly through an angle (Ø) of 360° (or a lesser range of angles) relative to the second coordinate frame origin (O₂).

It is to be noted that the tall, narrow form factor illustrated in each of FIGS. 2-6B reflects a presently-preferred aspect ratio for utilization in combination with an Organ Farm or Organ Interrogator, as described herein. However, other applications may benefit from other form factors and the particularly illustrated form factor is not to be taken as limiting on the concepts disclosed herein. In other aspects of the present concepts, modular microscope blades 100 may be configured with a form factor that is as “stout” as possible, with a minimized microscope blade height.

Although the carriage 220 itself is shown to comprise a platform to which the base 136 of the microscope blade 100 is attached, the carriage itself may comprise one or more motor(s), gear(s), actuator(s) to enable rotational and/or translational movement of the microscope blade 100 relative to the carriage (e.g., along the Y direction in FIG. 6A). Separately, as noted above, the microscope blade 100 itself comprises one or more positioning devices (e.g., motor(s), gear(s), actuator(s), etc.) permitting the stage 122 and/or other components of the microscope blade to be moved relative to the carriage 220.

As noted above, the microscope blades 100 described herein are conceived as modular microscopes designed for selective integration into instrumentation, such as the Organ Interrogator 300 device represented in FIG. 8. In alternate configurations, however, the microscope blades 100 may be optionally provided in a dedicated, non-modular configuration. By way of example, in a similar (non-preferred) variant, the microscope blade 100 could be permanently affixed to a nut/ball in a ball screw drive for linear motion along the screw element.

Although in various aspects of the present concepts the microscope blade(s) 100 are advantageously configured to move on a movable platform relative to a specimen or specimens (e.g., an Organ Chip 1, Organ Cartridge 10 and/or Cartridge Dock 30) in at least some other aspects of the present concepts, such specimen(s) may be configured to move relative to one or more stationary microscope blades 100. For example, with respect to FIG. 6A, with the carriage 220 in a first position relative to a first specimen (e.g., Organ Chip 1), actuators internal to the microscope blade 100 are used to position (along the X-Y axes) the optical train to focus (along the Z-direction) on a selected target position on the first specimen and to execute one or more microscopy imaging operations relative thereto (and optionally repositioning to image multiple target locations on the first specimen). Following completion of operations on the first specimen (e.g., Organ Chip 1), the carriage 220 is caused to move to a second position relative to a second specimen (e.g., Organ Chip 1′), with actuators internal to the microscope blade 100 again being used to position (along the X-Y axes) the optical train to focus (along the Z-direction) on a selected target position on the second specimen and to execute one or more microscopy imaging operations relative thereto (and optionally repositioning to image multiple target locations on the second specimen). Alternatively, a microscope blade 100, once set to image a particular location on a first specimen (e.g., Organ Chip 1), may following completion of the imaging operation, move immediately to image the same location on a second specimen (e.g., Organ Chip 1′), and then a third Organ Chip (e.g., Organ Chip 1″), and so on, so that macro adjustments in internal positioning of the constituent elements of the microscope blade are obviated, enabling finer adjustments and higher throughput.

Thus, in at least some aspects, the specimen, Organ Chip 1, Organ Cartridge 10 and/or Cartridge Dock 30 are integrated with a movable stage, such as a motorized stage comprising one or more motors or actuators configured to move the movable stage along one or more axes (e.g., X, Y, Z) or through a range of angles about one or more axes of rotation. In yet other aspects of the present concepts, both the microscope blade(s) 100 and the specimen, Organ Chip 1, Organ Cartridge 10 and/or Cartridge Dock 30 are each integrated with a movable stage, such as a motorized stage comprising one or more motors or actuators configured to move the movable stages along one or more axes (e.g., X, Y, Z) and/or through a range of angles about one or more axes of rotation, to permit simultaneous movement relative to one another. Although the examples above generally describe motion of the microscope blades 100 along axes in three dimensions (e.g., X, Y, Z), the microscope blades and/or the target objects may alternatively, or in addition, be configured for rotational movement. Thus, in at least some aspects, a base 136 is affixed to a motor-driven platform configure to rotate the microscope blade 100 through a range of angles (e.g., through θ of 360°) and the Organ Chips 1 can be disposed in a ring about the microscope blade 100, with the microscope rotating an appropriate degree to permit imaging of a targeted Organ Chip.

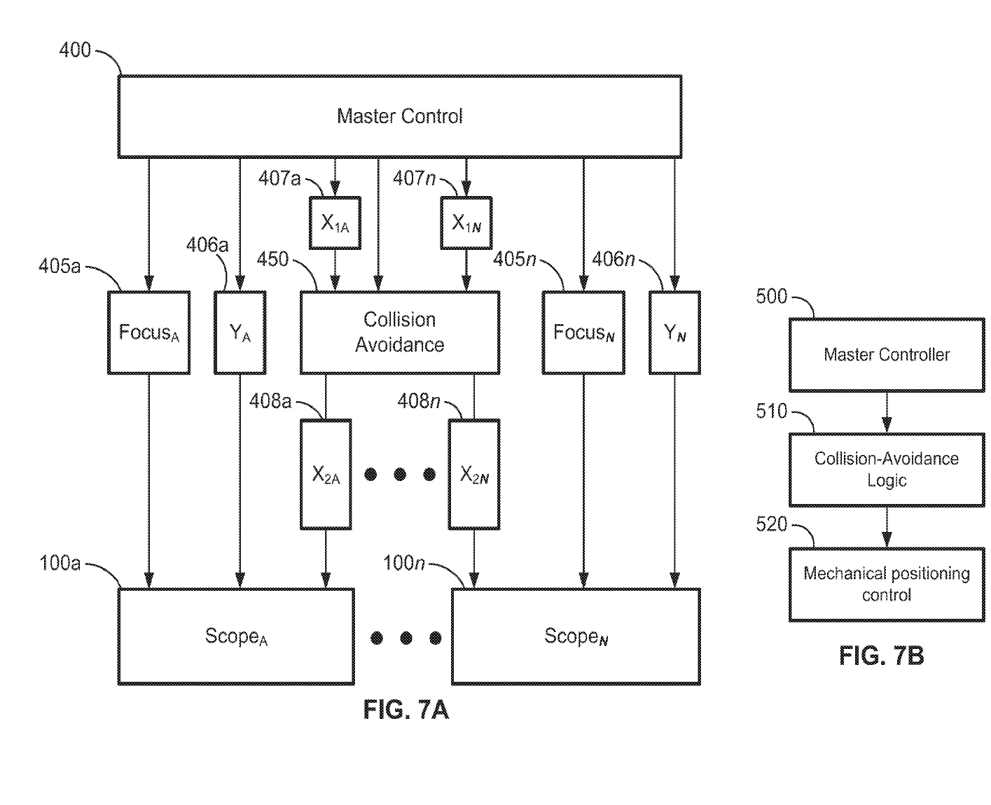

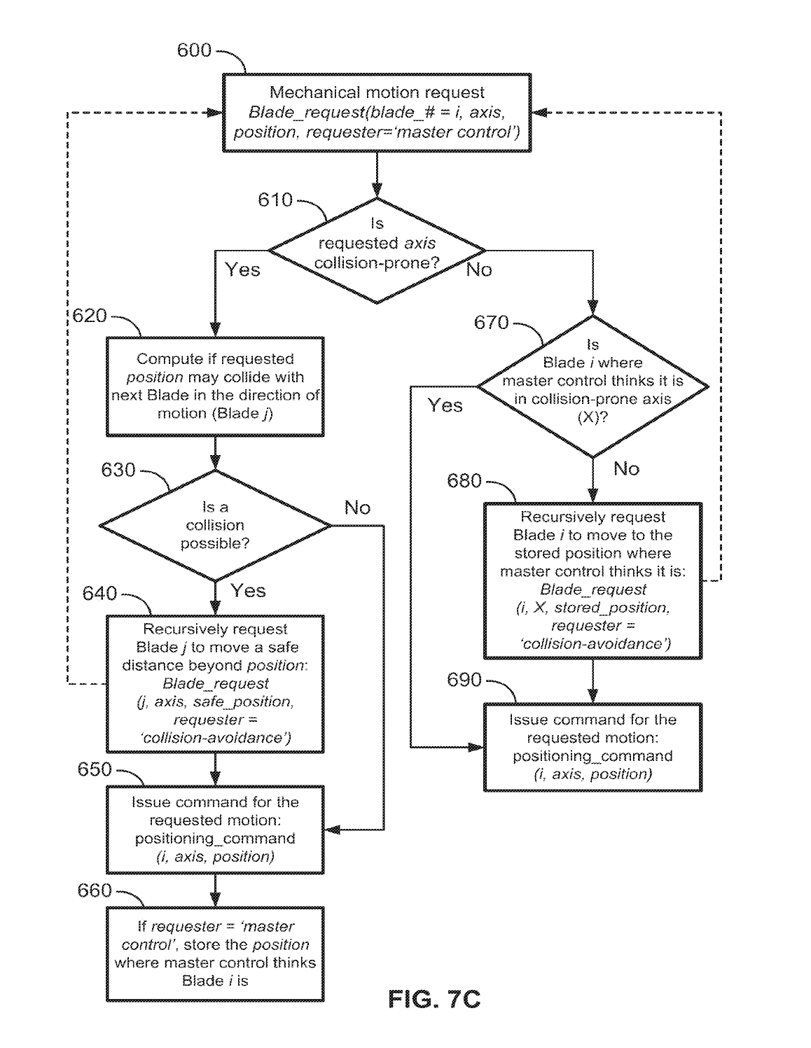

FIG. 7A shows one example of a control system for a modular microscopy system comprising a plurality of microscope blades 100a-n (where n is any integer) arranged to move relative to one another along an X-axis (see, e.g., FIG. 8). Master controller 400 is shown to output, to each of a plurality of microscope blades 100a-n (Scope_{A} . . . Scope_{N}, where N is any integer), a first mechanical motion request 406a comprising a first mechanical motion instruction (e.g., Y_{A}) along a first axis (Y-Axis) for the respective microscope blade (e.g., Scope_{A}). In various aspects of the present concepts, depending on whether the application and configuration of the microscope blades 100a-n require ganged movement or individual movement of the microscope blades, the first mechanical motion request can be the same to each of the microscope blades, or could be different as to one or more same microscope blades. Thus, first mechanical motion instruction (i.e., Y_{A}) to microscope blade 100a (Scope_{A}) can be the same as a first mechanical motion instruction (i.e., Y_{B}) to microscope blade 100b (Scope_{B}) where microscope blades 100a-100b are to move together.

The master controller 400 is also shown to output a second mechanical motion request 407a comprising a second mechanical motion instruction (e.g., X_{1A}) along a second axis (X-Axis) for the respective microscope blade 100a (Scope_{A}). However, rather than a direct instruction to the microscope blade 100a (Scope_{A}), or associated actuators, the second mechanical motion instruction is first passed to a collision avoidance controller 450 that is separate from the master controller 400. The collision avoidance controller 450 compares the second mechanical motion request (e.g., X_{1A}) to other second mechanical motion requests (e.g., X_{1B}, X_{1C}, . . . X_{1N}) to determine if a correction to one or more of the second mechanical motion requests (e.g., X_{1B}) is required to avoid contact between any of the plurality of microscope blades 100a-100b (e.g., Scope_{A} and Scope_{B}) along the second axis (i.e., the X-axis along which the microscope blades travel in the current example) arising from movement according to the second mechanical motion requests.

If the collision avoidance controller 450 determines that execution of the second mechanical motion requests (e.g., X_{1A} and X_{1B}) as output by the master controller 400 would cause or risk a contact between the microscope blades 100a-100b, the collision avoidance controller 450 determines appropriate corrections to one or more second mechanical motion requests (e.g., only X_{1A}, only X_{1B}, both X_{1A} and X_{1B}) to ensure that no such contact occurs. Following the comparison and determination, the collision avoidance controller 450 then outputs appropriate second mechanical motion requests 408a, 408n (e.g., X_{2A} and X_{2B} in the present example) to the respective microscope blades 100a-100b. If the original second mechanical motion request (e.g., X_{1A}, X_{1B}) output by the master controller 400 are determined by the collision avoidance controller 450 to be acceptable (i.e., microscope blades 100a-100b would not contact one another), then the collision avoidance controller would output second mechanical motion request 408a, 408n (e.g., X_{2A} and X_{2B}) that are the same as the second mechanical motion request (e.g., X_{1A}, X_{1B}) output by the master controller 400.

FIG. 7A also shows the master controller 400 to output to the microscope blades 100a-100n (Scope_{A} . . . Scope_{N}, where N is any integer), a third mechanical motion request 405a-405n comprising a third mechanical motion instruction (e.g., Focus_{A}) along a third axis (Z-Axis) for the respective microscope blade (e.g., Scope_{A}). In various aspects of the present concepts, depending on whether the application and configuration of the microscope blades 100 require ganged movement or individual movement of the microscope blades, the first mechanical motion request can be the same to each of the microscope blades, or could be different as to one or more same microscope blades. As is evident, the depicted third mechanical motion requests 405a-405n comprise instructions to each of the microscope blades 100a-100n to focus on a prescribed point.

It is to be noted that, although the present concepts include embodiments where the master controller 400 performs the functions described herein with respect to the collision avoidance controller 450, it is presently preferred (but not required) to provide the collision avoidance controller as a separate controller to alleviate the programming complexity or processing burden on the master controller.

FIG. 7B generally shows a control-flow diagram for a software system configured to control multiple microscope blades 100a-100n. This configuration beneficially allows the master controller 400 not to be encumbered by collision-avoidance logic. Rather, master controller 400 generates requests for mechanical motion that are then parsed by collision-control logic that augments the requests as needed before commands are passed (as originally received or as modified) to the mechanical hardware.

FIG. 7C shows a flow chart of one embodiment of a collision-avoidance logic in accord with at least some aspects of the present concepts that allows the master controller 400 to operate without care for collisions. The system, such as depicted in FIG. 7B, detects potential collisions along the collision-prone axis (e.g., the X-axis in the present example) and moves any microscope blade(s) (e.g., 100x) that may be in the collision path. To do so, the collision-avoidance logic invokes itself recursively, so that the generated collision-avoidance action is itself safe from collisions. Since microscope blade(s) that the master controller 400 did not address may end up moving, the collision-avoidance logic in this embodiment keeps track of the position commanded by the master controller (and/or the Δ thereof) and the collision avoidance controller 450 uses this information (i.e., the expected position and/or Δ of the current position from the expected position) in assessing further movement requests from the master controller 400. Subsequent movements may again be done by recursively invoking the collision-avoidance logic, so as to avoid collisions during movement.

Turning to FIG. 7C, block 600 shows receipt of a mechanical motion request for a microscope blade 100. In block 610, the collision avoidance controller 450 determines whether the request (for movement of microscope blade 100i) is along an axis about which the microscope blades 100 are collision prone. This particular determination may be omitted if the master controller 400 itself only outputs to the collision avoidance controller 450 mechanical motion requests along an axis along which a plurality of microscope blades 100 move (e.g., as shown in FIG. 7A). In the logic shown in FIG. 7C, all mechanical motion requests are routed to the collision avoidance controller 450.

If the collision avoidance controller 450 determines that the mechanical motion request is along an axis about which the microscope blades 100 are collision prone in block 610, control passes to block 620, where the collision avoidance controller computes if the position for microscope blade 100i requested by the master controller 400 may cause a collision with an adjacent microscope blade in the direction of motion (e.g., microscope blade 100j). If it is determined that a collision is possible between microscope blade 100i and microscope blade 100j, in block 630, the collision avoidance controller 450 recursively requests the affected microscope blade 100j to move to a safe distance beyond the position in question. If it is determined that a collision between microscope blade 100i and microscope blade 100j is not possible, in block 630, the collision avoidance controller 450 issues a command to microscope blade 100i to effect the requested motion. In block 660, if the requester is the master controller 400, the collision avoidance controller 450 stores the position at which the master controller thinks the microscope blade 100i resides.

If the collision avoidance controller 450 determines that the mechanical motion request for microscope blade 100i is along an axis about which the microscope blades 100 are not collision prone in block 610, control passes to block 670, where the collision avoidance controller determines if microscope blade 100i is at a position at which the master controller 400 believes it to reside. If yes, control passes to block 690, where the collision avoidance controller 450 issues a command to the microscope blade 100i to effect the requested motion. In block 670, if the collision avoidance controller 450 determines that microscope blade 100i is not a position at which the master controller 400 believes it to reside (i.e., the stored position), control passes to block 680, where the collision avoidance controller recursively requests the microscope blade 100i to move to the stored position.

The above examples merely reflect some non-limiting aspects of one example of collision-avoidance logic consistent with aspects of the present concepts. Other embodiments of collision-avoidance logic may also be advantageously utilized in combination with the microscope blade systems described herein, with tradeoffs naturally occurring between code complexity and the efficiency of the resulting motion. Unnecessary mechanical motion can be avoided using improved collision-avoidance algorithms or by adopting a design where the master controller 400 itself determines whether any microscope blades 100a-100n could contact one another and appropriately coordinate the movement of the microscope blades with suitable movements, timing, velocities and accelerations so as to avoid contact.

As noted above. FIG. 8 shows is a schematic representation of an embodiment of an Organ Interrogator 300 configured to permit a Cartridge-dock (not shown for clarity) to be examined by a plurality of microscope blades 100a-100n in accord with at least some aspects of the present concepts. As shown, the microscope blades 100a-100n are disposed to travel along a linear motor rail (see, e.g., FIG. 6A) subject to movement constraints imposed thereon by a collision avoidance controller 450 (see, e.g., FIGS. 7A-7C).

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities of ingredients or reaction conditions used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is synonymous with the term “for example,” and is non-limiting in nature.

All patents and other publications identified in the specification and examples are expressly incorporated herein by reference in their entirety for all purposes.

While particular embodiments and applications of the present disclosure have been illustrated and described, it is to be understood that the present disclosure is not limited to the precise compositions and combinations disclosed herein and that various modifications, changes, and variations, combinations or subcombinations can be apparent from the foregoing descriptions without departing from the spirit and scope of the invention as described herein and/or as defined in the appended claims.

1. A microscopy system configured for monitoring of one or more specimens, the microscopy system comprising:
a plurality of microscope blades, each of the plurality of microscope blades comprising at least one objective, at least one illuminator, and at least one detector;
a plurality of carriages, each of the plurality of carriages being connected to one or more of the plurality of microscope blades;
one or more actuators configured to drive the plurality of carriages along one or more axes, at least some of the plurality of carriages having at least partially overlapping ranges of motion along at least one of the one or more axes; and
a master controller configured to drive each of the plurality of carriages, using the one or more actuators, along the one or more axes.

2. The microscopy system according to claim 1, further comprising:
a collision avoidance controller configured to control movement of the plurality of microscope blades so that no moving microscope blade contacts any other microscope blade.

3. The microscopy system according to claim 2, wherein the collision avoidance controller is external to the master controller.

4. The microscopy system according to claim 2, wherein the master controller comprises the collision avoidance controller.

5. The microscopy system according to claim 3, wherein the master controller is configured to output mechanical motion requests for each of the plurality of carriages to the one or more actuators to direct movement of each of the plurality of carriages along the one or more axes, at least some of the mechanical motion requests being first passed by the master controller to the collision avoidance controller configured to determine if the at least some of the mechanical motion requests include any mechanical motion requests that would cause any of the plurality of microscope blades to contact any other one of the plurality of microscope blades and to output to the one or more actuators either the at least some of the mechanical motion requests or a corrected set of mechanical motion requests comprising one or more corrected mechanical motion requests together with the subset of the at least some of the mechanical motion requests that were not corrected.

6. The microscopy system according to claim 1, wherein at least one of the plurality of carriages comprises a docking interface bearing one or more mechanical connectors configured to matingly and removably engage corresponding mechanical connectors on the corresponding one of the plurality of microscope blades.

7. The microscopy system according to claim 6, wherein the docking interface further comprises one or more electrical connectors configured to matingly and removably engage one or more corresponding electrical connectors on the corresponding one of the plurality of microscope blades.

8. The microscopy system according to claim 6, wherein the plurality of carriages are independently driven, by the one or more actuators, along parallel axes.

9. The microscopy system according to claim 6, wherein the plurality of carriages are independently driven, by the one or more actuators, along a common axis.

10. The microscopy system according to claim 1, further comprising:
a carriage connected to a plurality of the microscope blades,
wherein the one or more actuators comprise one or more actuators configured to move the carriage bearing the plurality of the microscope blades.

11. The microscopy system according to claim 1, wherein the one or more actuators are configured to move at least one carriage about an axis of rotation.

12. The microscopy system according to claim 1, wherein each of the plurality of microscope blades comprises a focus control system, the focus control system comprising one or more of an electromagnetic motor, piezoelectric motor, sonic motor, voicecoil, or combination thereof.

13. The microscopy system according to claim 6,
wherein at least a plurality of the carriages are ganged together for simultaneous movement along the at least one axis of the one or more axes.

14. The microscopy system according to claim 1, further comprising:
at least one rail along which at least one of the plurality of carriages is disposed to translate.

15. The microscopy system according to claim 14,
wherein the at least one rail comprises a magnetic linear motor rail, and
wherein the at least one of the plurality of carriages, in combination with the magnetic linear motor rail, is configured to levitate with respect to surfaces of the magnetic linear motor rail.

16. The microscopy system according to claim 1,
wherein the one or more actuators configured to drive the plurality of carriages along one or more axes comprises a ball screw, belt, rack, or hydraulic actuator, and
wherein the plurality of carriages driven by the one or more actuators are configured with one or more components adapted to engage the one or more actuators and transmit forces from the one or more actuators to the plurality of carriages.

17. The microscopy system according to claim 1, wherein the one or more specimens comprise a plurality of Organ Chips each having a membrane with cells located thereon, the plurality of microscopy blades for imaging the cells in the plurality of Organ Chips.

18. The microscopy system according to claim 17, wherein each of the plurality of Organ Chips is disposed in a respective Organ Cartridge, each of the plurality of microscope blades being associated with a respective Organ Cartridge.

19. The microscopy system according to claim 18, further comprising:
one or more actuators configured to move the one or more Organ Chips, individually or in combination with one or more of the Organ Cartridge relative to the plurality of microscope blades.

20. The microscopy system according to claim 1, further comprising:
one or more motorized platforms disposed internally to at least one microscope blade of the plurality of microscope blades to move at least one component of an optical train relative to the at least one microscope blade.

21. The microscopy system according to claim 1, wherein the at least one detector comprises an imaging device.

22. The microscopy system according to claim 21, wherein the imaging device comprises a camera.

23. The microscopy system according to claim 21, wherein the at least one illuminator comprises at least one of a metal-halide lamp, a mercury arc-discharge lamp, a xenon lamp, a tungsten-halogen lamp, an incandescent tungsten lamp, a halogen lamp, an arc lamp, a laser, a monochromator, LEDs, OLEDs, or a flash tube.

24. The microscopy system according to claim 21, wherein each of the plurality of microscope blades are configured to support one or more microscopy modalities selected from the group comprising brightfield, darkfield, phase-contrast, epifluorescence, fluorescence, microfluorimetry, confocal, and multi-proton excitation microscopy.

25. The microscopy system according to claim 21, wherein at least one of the plurality of microscope blades comprises a phase condenser.

26. The microscopy system according to claim 24,
wherein a first microscope blade of the plurality of microscope blades is configured to support fluorescence and phase-contrast microscopy modalities, and
wherein a second microscope blade of the plurality of microscope blades is configured to support a confocal microscopy modality.

27. The microscopy system according to claim 1, wherein the plurality of microscope blades are configured to operate in parallel, in series, or a combination thereof.

28. A method of controlling a microscopy system comprising a plurality of movable microscope blades movably disposed along a range of positions along one or more axes, at least some of the plurality of positions for the plurality of movable microscope blades along the range of positions being at least partially overlapping, the method comprising:
using a controller, determining a mechanical motion request for a movable microscope blade disposed at a first location to move to a second location, at least one of the first location or the second location being within the at least partially overlapping ranges of motion along the one or more axes; and
using the controller, or another controller, to cause at least one actuator to move the movable microscope blade from the first location to the second location.

29. The method of controlling the microscopy system according to claim 28, further comprising:
using the controller or the another controller to determine if a correction to the mechanical motion request is required to avoid contact between the movable microscope blade and any of the remainder of the plurality of microscope blades arising from movement of the movable microscope blade in accord with the mechanical motion request and, if so, to output to the movable microscope blade or the at least one actuator a modified mechanical motion request; and
using the controller, or another controller, to cause the at least one actuator to move the movable microscope blade from the first location to the second location in accord with one of the mechanical motion request or the modified mechanical motion request.

30. The method of controlling the microscopy system according to claim 29, wherein a plurality of microscope blades are attached to a plurality of carriages disposed to translate along at least one rail.

31. The method of controlling the microscopy system according to claim 29, wherein the controller comprises a master controller, and
wherein the another controller comprises a collision avoidance controller.

32. The method of controlling the microscopy system according to claim 31, wherein the collision avoidance controller comprises the master controller.

33. The method of controlling the microscopy system according to claim 31, wherein the collision avoidance controller is external to the master controller.

34. The method of controlling the microscopy system according to claim 31, wherein the master controller, singly or in combination with the collision avoidance controller, is configured to cause a plurality of microscope blades to move simultaneously or sequentially along the rail.

35. The method of controlling the microscopy system according to claim 31, wherein the collision avoidance controller is utilized to analyze mechanical motion requests of microscope blades operating within the at least partially overlapping ranges of motion along the one or more axes.
